(19) United States
(12) Patent Application Publication
(10) Pub. No.: US 2015/0139715 A1
(43) Pub. Date: May 21, 2015

(54) NONSHIFTABLE COUPLING WITH TORQUE MONITORING

(71) Applicant: CENTA-ANTRIEBE KIRSCHEY GMBH, Haan (DE)

(72) Inventors: Jochen Exner, Hennef (DE); Martin Bach, Mettmann (DE); Jochen Forstmann, Haan (DE)

(21) Appl. No.: 14/413,810

(22) PCT Filed: Aug. 5, 2013
(86) PCT No.: PCT/DE2013/000431

§ 371 Date: Jan. 9, 2015

(30) Foreign Application Priority Data
Aug. 6, 2012 (DE) 10 2012 015 357.0

(51) Int. Cl. F03D 11/02; G01L 3/14; F03D 11/00

(52) U.S. Cl. CPC F03D 11/02; F03D 11/0091; G01L 3/14
USPC 403/27

(57) ABSTRACT

Device (10) for transferring torques from a first machine component (13) to a second machine component (12), particularly in a wind turbine (11), said device comprising a first connecting hub (19) for connecting to the first machine component (13), a second connecting hub (21) for connecting to the second machine component (12), and an intermediate tube (20), particularly made of glass fibre reinforced plastic, which is fixed at a first end to the first connecting hub (19) and at a second end to the second connecting hub (21), characterised in that the device (10) has at least one torque sensor (23), particularly an elongation measuring sensor, which is arranged on the first connecting hub (19) or on the second connecting hub (21).

The invention relates to a device for transmitting torque from a first machine part to a second machine part as set forth in the preamble of claim 1.

Devices of this type are well-known in principle and are also called nonshiftable couplings.

Corresponding devices are employed, for example, in wind turbines, but also, for example, in the marine and maritime sectors, or in hydropower installations.

The machine parts here can, for example involve a generator that is coupled to a transmission, for example a rotor of a wind turbine. These couplings or devices typically provide the connection between the machine parts, and the transfer of torque (in particular with a drive ratio of 1:1), as well as misalignment compensation, for example, in order to ensure relative movement without excessive restoring forces by the machine parts in wind turbines.

In addition to the intermediate tube between a first and a second connecting hub (or on a first or second flange), these devices typically also include elastic, kinematically active elements that are each mounted on the hub so as to provide a misalignment-compensating connection to the machine part. In typical devices of the applicant, these kinetic elements involve link-like assemblies of which a more precise description will be provided below. Alternatively, diaphragms and disks can be provided.

A basic monitoring capability for the device is desirable so as to ensure that this device and also the respective machine parts thereof (or the entire unit in which the device is used) operate without problems, and, for example, possible sources of failures are analyzed in test runs or also the operating state of the device is monitored continuously.

The object of this invention is therefore to improve the basic monitoring capability of such a coupling or of the entire unit in which the coupling is used.

This invention achieves the object in terms of a first aspect by the features of claim 1, in particular those of the characterizing part, and is thereby characterized in that the device includes at least one torque sensor that is mounted on the first connecting hub or on the second connecting hub.

The principle of the invention thus substantially consists in measuring torque transmitted in the device, and specifically where a torque sensor is not attached, as perhaps would be expected, to the intermediate tube, but instead is connected to one of the two connecting hubs that are connected to the intermediate tube.

While the intermediate tube can be composed, for example, of a fiber-reinforced composite, in particular fiberglass-reinforced plastic, the hubs are typically made of metal. It is possible here to effect a more advantageous measurement since the metal has properties that are more isotropic than the intermediate tube composed of a fiberglass reinforced plastic. This in principle would not be expected at first since these types of sensors usually tend to be mounted on homogeneous, axially longitudinally extending or (tubular)-shaft regions (for example tubes) of this coupling, since experts assume that this is where a more effective measurement can be made.

Based on an elaborate and time-consuming series of measurements, the applicant has determined that it is clearly possible to locate torque sensors (which can be implemented, for example, as measurement strips, in particular, strain gauges) on hubs that are axially very short relative to the intermediate tube.

This type of arrangement can in particular be effected on an attachment sleeve of one of the two hubs. The purpose of this attachment sleeve is to enable the intermediate tube to be attached, the intermediate tube being typically glued to this attachment sleeve of the connecting hub. To this end, the connecting hubs are of basic shape that is approximately cylindrically tubular.

Contrary to the expectation of experts, location of the sensor is thus effected in the “transition region” between the intermediate tube and the connecting tube or machine part.

The torque sensor is preferably provided in the form of a so-called strain gauge (abbreviated here as: DMS) such as those traditionally available commercially. Due to its flexible or nonrigid design, this measurement strip can be optimally located on the normally circular or cylindrically tubular curved inner surface of the attachment sleeve of one of the connecting hubs.

Without intending to discuss in more detail the measurement principle of these commercially available strain gauges, it should be mentioned that measurement of the torque is enabled by the (visually hardly perceptible) deformation of the monitored part (here: the connecting hub). Specifically, the deformation causes a wire located on the measurement strip to stretch such that this strip changes its electrical resistance, and this change can be detected or measured. To accomplish this, the torque sensor can also be connected, in particular, to an electronic unit mounted on the hub, which unit can also be provided, for example, in the form of a strip. In particular, the sensors and the electronic unit can also be integrated in the same strip. These torque sensors can be easily located by this approach on one of the connecting hubs, thereby, in particular, eliminating the need for any ancillary separate measurement shafts, and in overall terms this provides a simple construction and in turn simpler maintenance and also simpler monitoring of the complete coupling. In addition, the extra weight added by the measurement coupling is less than 200 g, which is very little compared to a separate measurement shaft. Separate measurement shafts can furthermore negatively affect the insulating properties of the coupling, whereas the invention readily allows an insulating fiberglass tube to continue to be used.

Couplings according to the invention are typically employed in wind turbines, specifically, as a coupling between the generator and the transmission of the rotor, or the rotor itself. Alternatively, however, use is also possible in other technical fields, such as hydropower equipment or maritime equipment, where the machine part can also be understood to refer to parts such as, for example, the actual rotor or a ship screw.

The intermediate tube of the coupling is typically glued at each end to one of the respective connecting hubs. To this end, the intermediate tube can fit over the connecting hubs. Alternatively, however, it is also possible for the connecting hubs to fit over the intermediate tube. The advantageous approach is for the intermediate tube to be composed of fiber-reinforced composite, in particular, fiberglass-reinforced plastic, although other materials can in principle be used to produce the intermediate tube.

Surprisingly, the torque sensor is not located on the intermediate tube but instead on one of the connecting hubs. Alternatively, one or multiple sensors can of course also be provided on both connecting hubs. In particular, it is advantageous for multiple, in particular two torque sensors to be provided on the hub to be monitored, the sensors being connected to the same electronic unit.

In an advantageous embodiment, the torque sensor is on the connecting hub that constitutes the output hub, that is, the hub to which the torque is subsequently transmitted within the force-transmission chain from the one machine part to the other machine part (at least in the case of a conventional transfer of torque from the transmission or the rotor to the generator).

Accordingly, the other connecting hub can typically be identified as the input hub. Since the torque sensor in a wind turbine is constrained by the available installation space, it is typically located on the connecting hub that is associated with the generator, that is on the output hub. A further reason for this may be the greater development of heat in the region of a brake disk of the rotor transmission.

It is possible in principle, however, to also use the other hub or input hub when locating the torque sensor. Specific aspects in terms of the available installation space must be taken into account here.

The connecting hub on which the torque sensor is located advantageously includes a connection sleeve to connect to the respective machine part and an attachment sleeve to connect to the intermediate tube. In particular, this connecting hub can be composed completely of these two sections, with the result that the connecting hub is then made up of the connection and attachment sleeves. The torque sensor here is advantageously located on the attachment sleeve. Relative to the connecting hub, the torque sensor is thus attached in the region that is fitted to the intermediate tube, and its purpose is thus to attach or mount this tube. The intermediate tube is typically glued to the attachment sleeve, and the torque sensor too is attached, in particular glued to this region.

Accordingly, the attachment sleeve can constitute all those regions of the connecting hub, whose purpose is not to connect to the respective machine part.

In another especially advantageous embodiment of the invention, the torque sensor is located in a region of the attachment sleeve that overlaps the intermediate tube. This allows for an especially optimal use of space. Alternatively, however, it is also possible to locate the torque sensor in a region of the attachment sleeve that does not overlap the intermediate tube, in particular whenever an especially long attachment sleeve is present.

In an advantageous arrangement, the torque sensor is furthermore located on that surface of the attachment sleeve to which the intermediate tube is not attached or glued. As a result, the intermediate tube can, for example, fit over the attachment sleeve of the respective connecting hub. In this case the torque sensor would be located on the inner surface of the attachment sleeve, opposite the intermediate tube, on the attachment sleeve. Alternatively, the attachment sleeve can also fit over the intermediate tube, in which case the torque sensor is located on the outer surface of the attachment sleeve (which is typically of cylindrically tubular shape).

In addition, the torque sensor is advantageously placed a certain spacing offset from the edge of the attachment sleeve, and thus, in particular not directly on the transition region between the attachment sleeve and the intermediate tube. A certain axial spacing remains here between the end of the connecting hub facing the intermediate tube and the site where the torque sensor is located. This results in higher measurement precision of the torque since it yields a more homogeneous measurement surface for the torque sensor, and in particular since a larger percentage of the torque has already been introduced into the connecting hub (for an output hub), or has not yet been introduced (for an input hub). In addition, the strain gradient in this edge region is disadvantageously steep due to the material transition.

The torque sensor is advantageously located in a region of the attachment sleeve of the output hub in which at least 50% of the torque has already be transmitted to the output hub.

It is furthermore advantageous that the location is in a region in which at least 75% has been transmitted.

The precise location must be determined based on the measurements to be made or theoretical calculations while taking into account the materials used and the dimensions of the connecting hub and the intermediate tube, as well as the adhesive that is used and the areas to which it is applied. However, the torque sensor is also advantageously placed a certain spacing offset from the connection sleeve of the hub since stress peaks, in particular notch stresses due to cross-sectional variations can typically occur in the transition region between the connection sleeve and the attachment sleeve.

In an especially advantageous embodiment of the invention, the connecting hub on which the torque sensor is mounted includes another torque sensor. This sensor can be located on or attached to the connecting hub, in particular substantially axially symmetrically, or axially symmetrically relative to the longitudinal axis of the coupling or the intermediate tube.

This arrangement allows for even more precise measurement since transverse forces and bending moments can be compensated. Measurement at these two points enables this deformation effect to be minimized, or to be computationally excluded from the measurement result. Alternatively, it is of course also possible to provide more than two sensors. It is advantageous in particular for these to be arranged angularly equispaced. A large number of sensors is advantageous since any errors caused by inhomogeneities then have a weaker impact.

It should be mentioned for the sake of completeness that a torque sensor in practice can also be composed of multiple sensors. Thus, according to the invention, a unit composed of multiple spatially or functionally interconnected torque sensors, for example, wires or measurement strips, can also constitute a torque sensor.

In terms of another aspect of the invention, the invention achieves the object described by the features of claim 8, in particular by those of the characterizing part, and is thus characterized in that the coupling includes at least one torque sensor that is connected to a transmitter and/or receiver that unit is mounted in the intermediate tube.

The functional principle of this aspect of the invention thus consists in actually locating a transmitter or receiver inside the torque-transferring intermediate tube, that is, inside the torque-transferring shaft. This unit ideally also includes both transmitting and receiving capabilities. However, this is not absolutely necessary to the invention; it is clearly also possible to provide only one transmitter or one receiver. The receiver can in particular handle supplying the coupling (and in particular supplying the torque sensor) with power, specifically, based on a so-called contactless transfer of power. The electronic unit connected to the torque sensor can also be supplied with power in this way.

On the other hand, the unit can also have transmitting properties such that signals or data that the torque sensor has captured are transmitted in contactless fashion from the torque-transferring intermediate tube (and thus from the rotating elements) externally to a stationary transmitter and/or receiver (so-called pick-up). This receiver can, for example, then be connected to a computer that analyzes the received signals or data. This can relate, for example, to the change in the electrical resistances of the measurement strips, which changes are then converted to the corresponding torque. Alternatively, a value for the torque can also be determined even prior to the transmission, specifically, by the electronic unit (that in particular can add digital coding), and these data sent by the antenna or the transmitter and/or receiver.

Contactless transmission provides advantages both with reference to visual aesthetics and safety technology in terms of wear-free operation. The approach furthermore avoids sparking, thereby providing improved explosion prevention.

The transmitter and/or receiver is advantageously located outside the overlap region of the intermediate tube and the attachment sleeve of the hub in order to achieve an improved transmission and/or reception performance.

The transmitter and/or receiver is advantageously installed permanently inside the intermediate tube, for example, on the inner curved surface of the intermediate tube. To this end, the unit can, for example, lie flat against the inner surface of the intermediate tube and be glued there in place.

In an especially advantageous embodiment of the invention, the transmitter and/or receiver is implemented as an inductive element, for example, an inductive ring that can be mounted on the intermediate tube and glued there in place extending circumferentially. Alternatively, the element can also be a coil comprising multiple inductive turns, with the result that multiple turns are located on the inner surface of the intermediate tube or glued there in place.

It should be noted at this point that the electronic unit too can be integrated into the transmitter and/or receiver, with the result that this unit is necessarily also mounted in the intermediate tube. Alternatively, however, the electronic unit can also be located in the hub, in particular placed a certain spacing offset from the antenna.

In especially advantageous fashion, this approach also enables a contactless transfer of power to be effected—but also transmission of signals and data. Of course other contactless power and/or data transmission elements can also be employed. It is possible, for example, to provide the transmitter and/or receiver in the form of a simple Bluetooth transmitter, and no receiver of any kind is provided for power transmission. The torque sensors in this case can be operated by batteries, along with any electronic unit mounted in the hub.

Additional advantages of the invention are seen in the dependent claims and in the following description of embodiments shown in the figures. Therein:

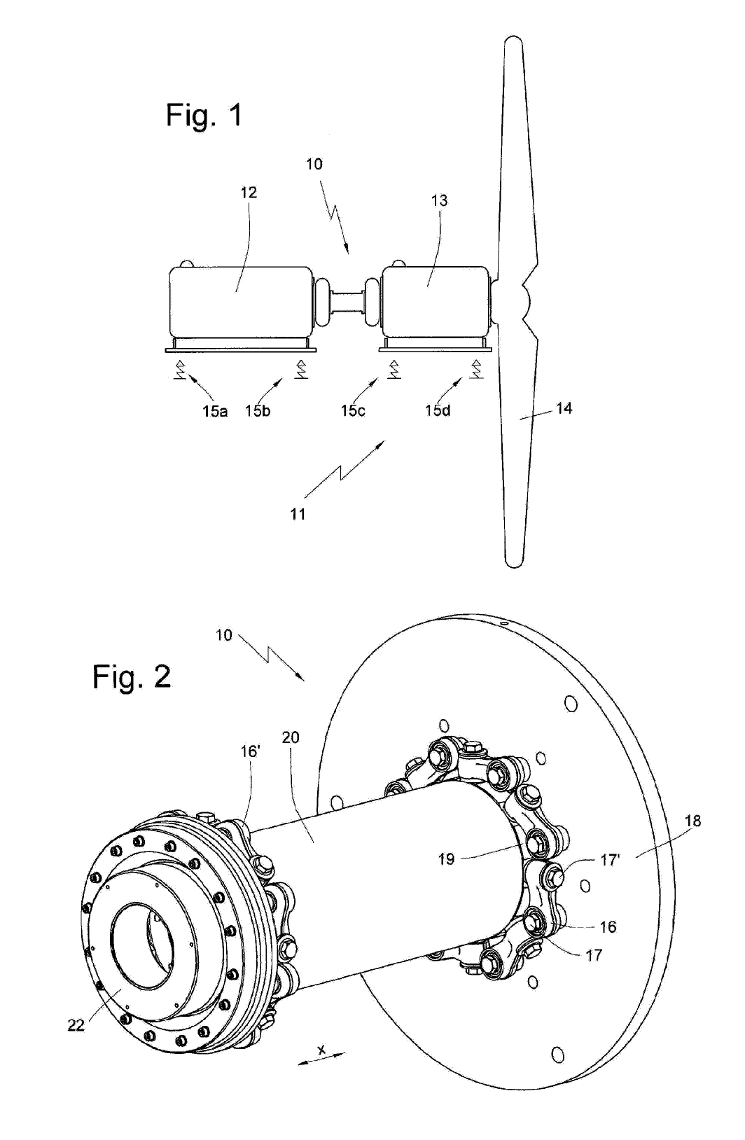

FIG. 1 is a rough schematic diagram, not to scale, that shows an embodiment of a coupling according to the invention in a wind turbine;

FIG. 2 is a schematic perspective view of a coupling according to the invention that has one end carrying a brake disk of an unillustrated transmission and another end connected to an overload unit that is associated with an unillustrated generator;

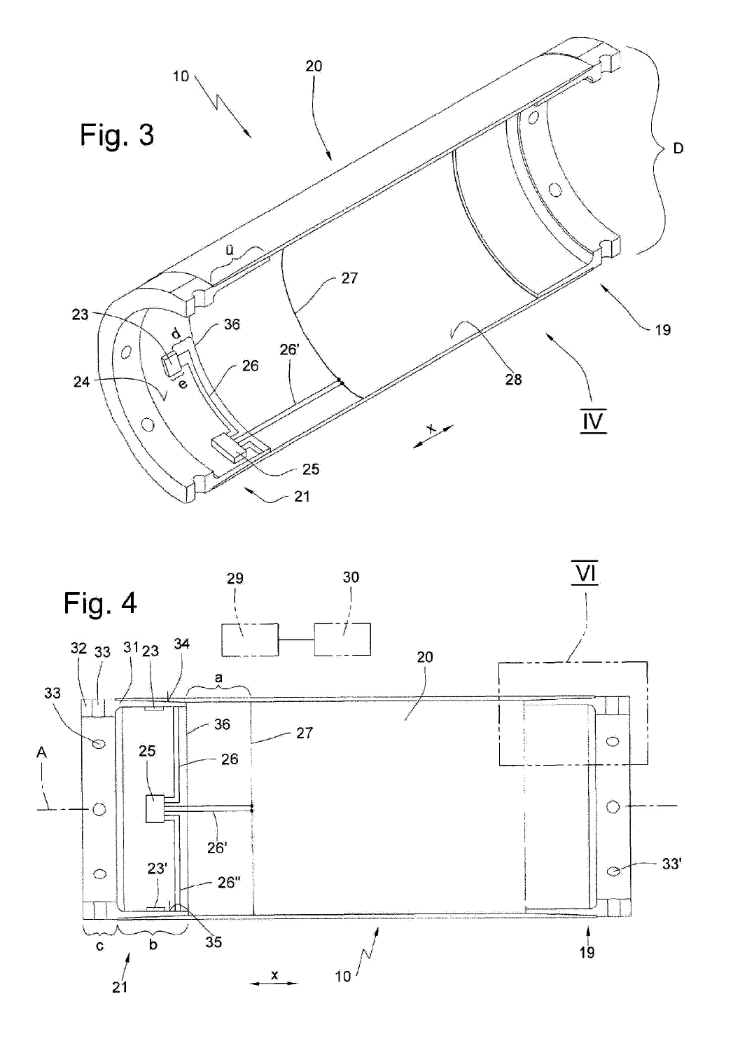

FIG. 3 is a perspective sectional view like FIG. 2 through the coupling according to the invention of different dimensions, and omitting the end fittings shown in FIG. 2;

FIG. 4 is a sectional view of a coupling as in FIG. 3, approximately as shown by arrow IV in FIG. 3, together with a transmitter and/or receiver and connected computer;

FIG. 5 is a graph across the length of the attachment sleeve shown in FIG. 4, where the graphed curve indicates the percentage by which the torque in the intermediate tube is transmitted to the metal connecting hub; and

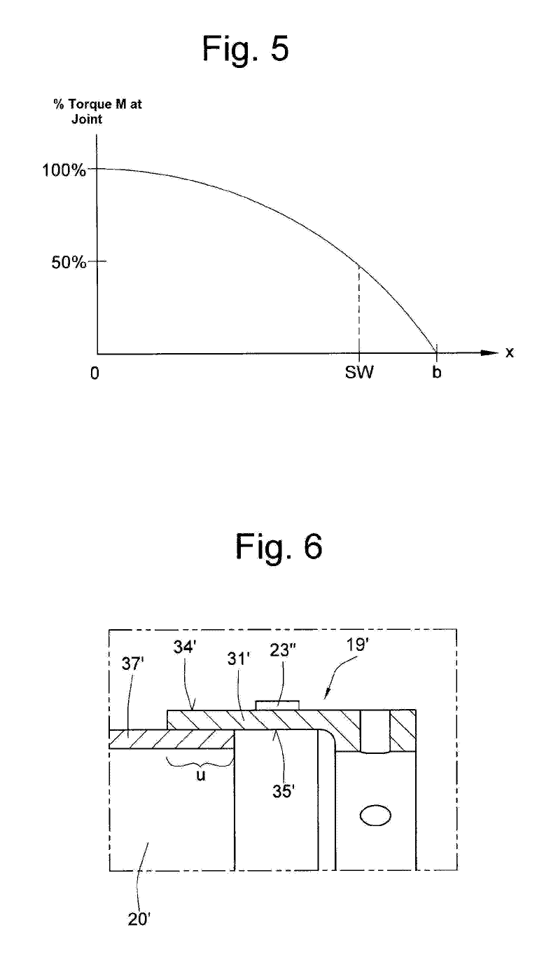

FIG. 6 is a schematic partial section of a second embodiment of the invention, of the region indicated in FIG. 4 approximately at VI, where the sensor is associated with the other connecting hub and the illustrated connecting hub overlaps the intermediate tube.

The complete coupling according to the invention, identified in the figures at 10, is shown in FIG. 1 in a wind turbine 11. This clearly illustrates that the coupling 10 according to the invention is provided between a generator 12 of the wind turbine 11 and a transmission 13.

Wind drives a rotor 14 such that torque can be transmitted by the coupling 10 to the generator 12. The torque in this embodiment is transmitted at a ratio of approximately 1:1, this being enabled by the coupling 10 according to the invention. In addition, the coupling 10 provides misalignment compensation, for example compensating for any displacement of the machine parts, since the generator 12 and also the transmission 13 in the wind turbine 11 are typically mounted elastically on elastic bearing points shown schematically at 15a through 15d.

The transfer is effected as much as possible homokinetically, i.e. uniform input rotation should result in uniform output rotation.

The coupling in the embodiment shown has links 16, shown in FIG. 2, in order to compensate for misalignment. The links 16 in FIG. 2 are connected to a brake disk 18 by respective threaded bolts 17 so as to be able to pivot about the threaded bolts 17 extending in axial direction x of the coupling 10. The brake disk 18 here is part of the transmission 13 that is not shown in FIG. 2, but that with reference to FIGS. 2 and 3 would be located to the right relative to the plane of the figures.

The links are attached to a connecting hub 19 indicated only partly in FIG. 2 for pivoting about radially extending threaded bolts 17′ offset by 90°. The illustrated coupling 10 can thus also be identified as a linkage, and is of a construction that has radially bolted cylindrical bushings and axially bolted spherical bushings in the link eyes of the link assembly.

The hub 19 is connected through an intermediate tube 20 to a second connecting hub, not shown in FIG. 2, specifically, a connecting hub 21 (see FIG. 3). As a result, connecting hub 19 that is associated with the transmission 13 or the brake disk 18 can also be identified as the input hub.

Although the connecting hub 21 cannot be seen in FIG. 2, the drawing shows that links 16′ are also provided here that are similarly connected to an overload unit 22. This unit 22 is connected to the generator 12, also not shown in FIG. 2. With reference to FIGS. 2 and 3, the generator 12 would thus be located relative to the plane of the figure to the left of the shown parts.

Both the first connecting hub 19, which can also be identified as the input hub, and the second connecting hub 21, which can be identified as the output hub, are seen in FIG. 3.

FIG. 3 furthermore shows a torque sensor 23 that is provided in the form of a glued-on strain gauge. The torque sensor 23 is also indicated only partly in FIG. 3. Its elastic property in particular cannot be seen in FIG. 3. In fact the thickness of the sensor 23 is exaggerated in FIG. 3 and it is shown simply as a schematic box. The torque sensor in practice, however, can be flexible, like an adhesive sticker, and can conform to the inner contour 24 of the hub 21 (and thus be glued into the hub 21). The sensor here typically has a width e of 3 to 10 mm. FIG. 3 also shows an electronic module 25 that is connected by wires 26 to the torque sensor 23. This electronic module can also be provided in the form of a flexible adhesive element so as to have the least possible effect on rotation of the coupling 10.

This module 25 in particular can gather information from the torque sensor 23 and from a second the torque sensor 23′, not shown in FIG. 3, and as required immediately analyze or further process or transmit this information further. This further transmission is effected through wires 26′ that are connected to an induction ring 27. This ring 27 in the illustrated embodiment is glued onto the inner curved surface or inner face 28 of the intermediate tube 20 and extends substantially 360° around the intermediate tube. The intermediate tube typically has a diameter of 200 to 1000 mm, for example 300 mm.

Alternatively, a coil comprising multiple circumferential turns can also be installed on the inner curved face 28 of the intermediate tube 20 and glued there in place, replacing an substantially single-turn ring 27.

FIG. 4 shows that a transmitter and/or receiver 29 (that is also part of the coupling 10) is provided outside the intermediate tube 20 and connecting hubs 19 and 21 in order to supply power, in particular to the torque sensor 23. The transmitter and/or receiver 29 here is stationary (for example, in a housing of the wind turbine 11), and is in particular not inside the rotating intermediate tube 20. The induction ring 27 rotating together with the intermediate tube 20, which can also be identified as an antenna, can thus exchange both power and also signals without contact with the stationary transmitter and/or receiver 29. An alternating current, for example, can be applied for this purpose by the transmitter and/or receiver 29 so as to generate a magnetic field that generates an electrical current in the antenna 27, enabling power to be supplied to the torque sensor 23.

On the other hand, the torque sensor 23 can measure information about the torque from the connecting hubs 19 and 21, and the intermediate tube 20 during a rotation of the unit, and generate signals from which measurement values relating to the monitored torque can determined at least indirectly. These signals can pass from the torque sensor 23 through wires 26 to the electronics 25, and from there through wires 26′ to the antenna 27 that then through contactless means transmits these signals to the transmitter and/or receiver 29 mounted stationarily inside the wind turbine. The receiver 29 can then, for example, relay these signals to a computer, also shown schematically in FIG. 4, to which, for example, input devices such as keyboards or input accessories, as well as a display, such as a monitor or speakers can be connected. The wires shown in FIG. 4 between transmitter and/or receiver 29 and the computer 30 should be understood to be merely symbolic. This may in fact relate to a physical wire, or also, on the other hand, to a wireless connection or similar means. As a result, remote access to the transmitter and/or receiver 29 is definitely possible.

The fact that the intermediate tube 20 in this embodiment is made of a fiberglass reinforced plastic also enables both the antenna 27 and also the transmitter and/or receiver 29 to communicate through the intermediate tube without being significantly affected. Protection is furthermore provided against damage to the elements inside the intermediate tube. The antenna 27 here should be a certain spacing a from the closer hub 21 since the connecting hubs 19 and 21 are usually composed of metal and would interfere with communication between the antenna 27 and station 29.

The spacing a, on the other hand, must also not be excessive since the torque sensor is mounted on the hub 21.

The coupling is associated with the torsionally stiff couplings.

Joint rotation of both connecting hubs 19 and 21 together with the intermediate tube 20 is effected by the drive rotor 14 shown in FIG. 1 and enables the torque sensor 23 to collect information on the resultant generated torque. The torque sensor for this purpose is provided in this embodiment in the form of strain gauge that includes at least one wire. The wire changes its electrical resistance in response to deformation of the body since the wire is stretched, which deformation is necessarily created during rotation. The signal on the change in the electrical resistance supplies the information here about the torque. This information can be converted into actual values for the torque, for example, in the electronic module 25 or also in the computer 30.

Since it is possible for a measurement at a single location within the hub 21 to provide slightly distorted results due to inhomogeneities in the material and to the lack of compensation for transverse forces and bending moments, FIG. 4 shows that the second torque sensor 23′ is mounted relative to the longitudinal axis A of the unit consisting of connecting hubs 19, 21 and the intermediate tube 20 approximately axially symmetrically relative to this axis A (also inside the hub 21). This second torque sensor 23′ is also connected to the electronic unit 25 through the wires 26″.

A critically important aspect for the invention here is first of all that the torque sensors 23 and 23′ are mounted on one of the metal connecting hubs 19 and 21 and not, as might possibly be expected, directly on the intermediate tube 20. In particular, these sensors 23 and 23′ are attached here to an attachment sleeve 31 of the hub 21. To this end, the hub 21 is substantially of two-part design, and in addition to the attachment sleeve 31 (of a length b in the axial direction x) also has a connection sleeve 32 (of length c). The connection sleeve here is formed multiple screw mounts or threaded holes 33 for connecting the links 16′ to the hub 21. The same applies for holes 33′ in the connecting hub 19 and the links 16, not shown in FIG. 4.

FIG. 4 furthermore reveals that the attachment sleeve 31 of the hub 21 is of slightly conical shape. Since this aspect is not absolutely necessary for implementing the invention, however, an embodiment can also be provided in which the attachment sleeve 31 is not conical.

The attachment sleeve 31 here is in particular overlapped completely by the intermediate tube 20 and is glued on over its entire outer surface by an adhesive layer, not shown in the figures. Gluing is effected in the embodiment shown in FIG. 4 on the outer surface of the attachment sleeve 31, and the torque sensors 23 and 23′ are attached to an inside surface 35 of the attachment sleeve 32, in particular also glued permanently in place.

The sensors 23 and 23′ are here mounted where the attachment sleeve is adhered to and overlaps the tube 20. This overlap region in the embodiment shown in FIG. 4 extends substantially along the entire length b of the attachment sleeve 31.

Also seen in FIG. 4 is the fact that the sensors 23 and 23′ are mounted a certain spacing away from the connection sleeve 32 and from an edge 36 of the hub 21. This spacing is shown in FIG. 3 at d.

The reason for this is that the torque of the intermediate tube 21 at the edge 36 of the hub 21 has not yet been sufficiently transmitted to the metal of the hub 21.

FIG. 5 is intended to illustrate this in a graph where the percentage of the torque is plotted that has already been transmitted into the hub 21, specifically, versus the axial extent of the attachment sleeve 31 of hub 21. The point b here represents the edge 36 in FIG. 4. The attachment sleeve 31 here is of the length b. FIG. 5 also shows in particular a threshold value SW from which already 50% of the torque has been taken up by the attachment sleeve 31. This graph thus demonstrates that relative to the length b of the attachment sleeve torque sensors 23 and 23′ should as much as possible not be located in the region that lies between points SW and b in FIG. 5. In other words, the sensor must not be located too close to the edge 36 of the hub 21, which edge is identified at b.

In terms of the illustrated embodiment, FIG. 4 shows that the sensors 23 and 23′ are on the hub 21. The reason for this in particular is that conditions of space are more advantageous here relative to the spatial location of the transmitter and/or receiver 29 than a location for sensors 23 and 23′ on the connecting hub 19. FIG. 2 shows the very wide construction of the brake disk 18 that does not leave much space for a stationary transmitter and/or receiver. The station 29 is advantageously mounted on the body of the generator or transmission in order to maintain the shortest possible spacing to the antenna, or in order to have to overcome only the smallest possible air gap.

Additionally or alternatively, it is obviously also possible, however, to dispose one or more torque sensors on the input hub 19.

The graph shown in FIG. 5 would in this case be mirror-symmetrical. A corresponding torque sensor would also be provided in a region of the respective attachment sleeve in which a large percentage of the torque has to the greatest extent possible not yet been transmitted to the intermediate tube 20.

A second embodiment of the invention that is shown in part and in enlarged fashion in FIG. 6 is provided to illustrate this. Shown here is a region of the intermediate tube 20′ and a corresponding input hub 19′. In terms of its essential constructive design, this embodiment substantially matches the coupling shown in FIG. 4—however, with differences that are evident in FIG. 6. Relative to FIG. 4, however, the section shown in FIG. 6 would be located in the highlighted region shown at VI. The difference, however, is that the intermediate tube does not fit over the attachment sleeve 31′ of the connecting hub 19′. Instead the reverse is true: The attachment sleeve 31′, which in this embodiment is not at all conical, fits over the intermediate tube 20′ or its outer surface 37′. Another obvious aspect is that the torque sensor 23″ in this embodiment is not even located in the overlap region between the attachment sleeve 31′ and the intermediate tube 20′ but instead is axially offset from the overlap region u. Nevertheless the attachment sleeve 31′ can be significantly longer for this purpose than in the first embodiment. In addition, the sensor 23″ is located on the outer surface 34′ of the attachment sleeve 31′ rather than on the inner surface 35′ of this sleeve.

This second embodiment is intended to disclose several fundamental alternatives that can readily be combined with the embodiment of the coupling shown in FIGS. 1 through 5 and are intended only to modify the coupling without losing the core idea of the invention. It is obviously not necessary to implement all of the described differences in a coupling according to the invention. The invention is intended to comprise any combination of features of the embodiments in FIGS. 1 through 5 and FIG. 6.

1. A coupling for transmitting torque from a first machine part to a second machine part in a wind turbine, the coupling comprising:
a first connecting hub for connection to the first machine part,
a second connecting hub for connection to the second machine part,
an intermediate tube of fiberglass reinforced plastic, extending along an axis, and having a first end connected to the first connecting hub and an axially opposite second end connected to the second connecting hub, and
at least one strain-gauge torque sensor mounted on the first connecting hub or on the second connecting hub.

2. The coupling according to claim 1, further comprising:
a transmitter or receiver connected to the torque sensor and mounted in the intermediate tube.

3. The coupling according to claim 1, wherein the connecting hub on which the torque sensor is mounted includes
a connection sleeve connected to the respective machine part and
an attachment sleeve connected to the intermediate tube that transmits torque, the torque sensor being mounted on the attachment sleeve.

4. The coupling according to claim 3, wherein the torque sensor is located in a region of the attachment sleeve that overlaps the intermediate tube.

5. The coupling according to claim 3, wherein the torque sensor is placed a certain spacing offset from an end edge of the attachment sleeve where 50% of the torque has been transmitted between the intermediate tube and the connecting hub.

6. The coupling according to claim 3, wherein the intermediate tube is attached to the inner surface or the outer surface of the attachment sleeve, the torque sensor being mounted on the opposite surface.

7. The coupling according to claim 1, wherein the connecting hub on which the torque sensor is mounted includes a first torque sensor mounted on the connecting hub and a second torque sensor mounted on the connecting head diametrically opposite the first torque sensor.

8. A coupling for transmitting torque from a first machine part to a second machine part in a wind turbine, the coupling comprising:
a first connecting hub for connection to the first machine part,
a second connecting hub for connection to the second machine part,
an intermediate tube of fiberglass reinforced plastic, extending along an axis, designed to transmit torque, and having a first end connected to the first connecting hub and an axially opposite second end connected to the second connecting hub,
at least one torque sensor, and
a transmitter and/or receiver mounted in the intermediate tube and connected to the torque sensor.

9. The coupling according to claim 8, wherein the transmitter and/or receiver is permanently installed on an inner curved surface of the intermediate tube.

10. The coupling according to claim 8, wherein the transmitter and/or receiver is an inductive ring mounted in the intermediate tube or an inductive coil comprising multiple turns.

11. The coupling according to claim 8, wherein the transmitter and/or receiver supplies the torque sensor with power, and/or that the transmitter and/or receiver can send signals received from the torque sensor to a stationary receiving unit.
